(19) United States
(12) Patent Application Publication
(10) Pub. No.: US 2008/0177912 A1
(43) Pub. Date: Jul. 24, 2008

(54) SEMICONDUCTOR INTEGRATED CIRCUIT AND DATA PROCESSING SYSTEM

(76) Inventor: Michio ONDA, Tokyo (JP)

Correspondence Address: MILES & STOCKBRIDGE PC, 1751 PINNACLE DRIVE, SUITE 500, MCLEAN, VA, 22102-3833, US

(21) Appl. No.: 11/970,503

(22) Filed: Jan. 7, 2008

(30) Foreign Application Priority Data
Jan. 22, 2007 (JP) 2007-011137

(51) Int. Cl. G06F 13/38

(52) U.S. Cl. 710/68

(57) ABSTRACT

To contribute to increase data transmission rate for server management without increasing load during normal operation.

A semiconductor integrated circuit includes: a central processing unit; an external memory interface circuit; a network interface circuit; an image processing unit; and a data compression unit. The image processing unit performs image processing in response to an input from an external bus, the image processing unit is coupled to an external memory interface circuit through a dedicated internal bus, and the image processing unit stores an image data into an external memory via the dedicated internal bus. The compression unit is coupled to the image processing unit and is capable of compressing the image data supplied from the image processing unit. Since the dedicated internal bus, through which the image processing unit receives image information and stores the same into the external memory, is separated from the common internal bus, the data for image processing by the image processing unit that responds to an instruction from the outside will not conflict with the data for data processing by an instruction from the network interface circuit on the common internal bus.

### CROSS-REFERENCE TO RELATED APPLICATION

The disclosure of Japanese Patent Application No. 2007-11137 filed on Jan. 22, 2007 including the specification, drawings and abstract is incorporated herein by reference in its entirety.

### BACKGROUND OF THE INVENTION

The present invention relates to semiconductor integrated circuits that may be utilized for remote management of a server, and furthermore to semiconductor integrated circuits for achieving an interface function compliant with IPMI (Intelligent Platform Management Interface) or the like, and relates to techniques effectively applied to a data processing system, such as a server with a remote management function, for example.

A general motherboard for a computer includes: a main CPU; a north bridge such as a memory controller hub; a south bridge such as an I/O controller hub; a graphics controller; a network interface controller; a peripheral input output circuit (a keyboard, a mouse, an FDD, a CD-ROM, a serial port, a parallel port, a modem, and the like); a main memory; and other functions. As a part of remote management function in a PC server using the above-described motherboard, there is a function which, when operating a remote computer (hereinafter, also referred to as a remote machine) such as a remote server, sends information on the operation of a keyboard, a mouse, or the like from a local computer (hereinafter, also referred to as a host machine) via a network and then which, after performing the processing required on the remote machine, sends screen information (video information) to the host machine via the network in a similar manner and displays the same on a screen. In this case, the data amount of the video information is extremely large as compared with that of the keyboard and the mouse, and therefore, depending on the bandwidth of the network for data transmission, a data compression function may be implemented by software or a dedicated hardware in order to suppress the data amount to no more than the actual transferable data amount. Moreover, the data transmitted via the network contains not only the data for the keyboard and mouse and the video information but also the data for all the peripheral devices, such as a FDD, a modem, a CD-ROM, a hard disk, and the like that are coupled to the remote computer.

In addition, an example of the documents that describe the remote management function of a server is Japanese patent laid-open No. 2004-326737. The detail of IPMI, which is an interface specification for the remote management, is available from Intel web site http://www.intel.com/design/servers/ipmi.

### SUMMARY OF THE INVENTION

The above-described remote control function has been conventionally realized on a motherboard of a computer, such as PC, a server, or the like, by combining BMC (baseboard management controller), a graphics controller, and a data compression controller that are individually large scale integrated, respectively. In such a multichip configuration, these multiple LSIs individually have a data processing memory, thus increasing the number of components and the cost. An increase in the number of components also leads to an increase in the mounting area of a set, resulting in also an obstacle for achieving miniaturization and high density mounting of the set. By the same token, since the signals are wire-connected on the motherboard, restrictions and the like in terms of the circuit design occur in achieving a high-speed operation, thus resulting in an obstacle for improving the performance. However, when the BMC, the graphics controller, and the data compression controller are integrated into one chip, it is difficult to obtain the maximum performance improvement just by coupling these to a common bus. The graphics controller is not used just for the remote management function, and thus consideration is required so that the operation of BMC will not increase the load of a server and the like during normal operation. Moreover, in terms of the BMC functionality, it is also important to realize a flexible reset function corresponding to the conditions of the system such as a server.

It is an object of the present invention to provide a semiconductor integrated circuit that contributes to increase the data transmission rate for server management without increasing the load during normal operation.

Another object of the present invention is to provide a data processing system that can achieve increase in the data transmission rate for server management without increasing the load during normal operation.

The above and other objects and novel features of the present invention will be apparent from the description and accompanying drawings of this specification.

A summary of a representative invention among the inventions disclosed in the subject application is described briefly as follows.

That is, a semiconductor integrated circuit concerning the present invention includes in one semiconductor substrate: a central processing unit; an external memory interface circuit; a network interface circuit; an image processing unit; and a data compression unit. The image processing unit performs image processing in response to an input from an external bus, the image processing unit is coupled to an external memory interface circuit by a dedicated internal bus, and the image processing unit stores an image data into an external memory via the dedicated internal bus. The compression unit is coupled to the image processing unit and is capable of compressing the image data supplied from the image processing unit. According to this, the dedicated internal bus, through which the image processing unit receives image information and stores the same into an external memory, is separated from the common internal bus. Since the central processing unit together with the network interface circuit is coupled to the common internal bus, and a data path that is not required to go via this common internal bus is set to the dedicated internal bus, the data for image processing by the image processing unit that responds to an instruction from the outside will not conflict with the data for data processing by an instruction from the network interface circuit on the common internal bus. Since these are formed on one semiconductor substrate, the data transmission rates on the common internal bus and the dedicated internal bus are high.

The representative invention among the inventions disclosed in the present application is described briefly as follows.

Namely, this invention can achieve increase in the data transmission rate for server management without increasing the load during normal operation.

### BRIEF DESCRIPTION OF THE DRAWINGS

FIG. 1 is a block diagram illustrating a main board of a PC server as a data processing device concerning the present invention.

FIG. 2 is a block diagram showing an example of a BMC mixed LSI.

FIG. 3 is a block diagram illustrating a data flow when using DMAC for outputting image information of a screen on a remote machine to a host machine via a network.

FIG. 4 is a block diagram illustrating a data flow when encrypting for outputting image information of a screen on the remote machine to the host machine via a network.

FIG. 5 is a block diagram illustrating a data flow when outputting information of peripheral devices, such as a keyboard and a mouse on the remote machine, to the host machine via a network.

FIG. 6 is a block diagram illustrating the BMC mixed LSI in which a buffer memory is provided in each of an image processing unit and a compression unit.

FIG. 7 is an explanatory view showing the meanings of a first to a third types of internal reset signals.

FIG. 8 is a flowchart illustrating an internal reset control procedure by a central processing unit for an internal circuit coupled to a common internal bus.

### DETAILED DESCRIPTION OF THE PREFERRED EMBODIMENTS

### 1. Representative Embodiment

First, an overview concerning a representative embodiment of the invention disclosed in the present application will be described. Reference numerals in the accompanying drawings that are referred to with a parenthesis in the overview description concerning the representative embodiment just exemplify the one contained in the concept of a constituent element with the parenthesized reference numeral.

[1] A semiconductor integrated circuit (20) concerning a representative embodiment of the present invention comprises in one semiconductor substrate: an image processing unit (23) that performs image processing in response to an input from an external bus (15); a compression unit (24) coupled to the image processing unit and capable of compressing an image data; and an interface unit (25) that may be utilized for server management. The interface unit includes a central processing unit (31), an external memory interface circuit (32), and a network interface circuit (33) that are coupled to a common internal bus (30). The external memory interface circuit may be coupled to an external memory (22). The network interface circuit may be coupled to an external network controller (17). The compression unit is coupled to the common internal bus. The image processing unit is coupled to the external memory interface circuit by a dedicated internal bus (37), and the image processing unit stores an image data into the external memory via the dedicated internal bus. The compression unit is capable of compressing the image data supplied from the image processing unit.

When the above-described semiconductor integrated circuit is mounted, for example, on a server and is utilized for remote management, in the case where a processing required on a remote machine is executed via a network and thereafter screen information of the remote machine is transmitted to a host machine via a network, the dedicated internal bus, through which the image processing unit receives the image information and stores the same into the external memory, is separated from the common internal bus. Since the central processing unit together with the network interface circuit for remote management is coupled to the common internal bus, and a data path that is not required to go via this common internal bus is set to the dedicated internal bus, the image data for graphic processing by the image processing unit that responds to an instruction from the external bus will not conflict with the data for memory management on the common internal bus. Since these are formed on one semiconductor substrate, the data transmission rates on the common internal bus and the dedicated internal bus are high. The external memory coupled to the external memory interface can be used also for a buffer memory for image compression, a work memory of the central processing unit, and the like, and thus the memory can be commonized.

As a specific embodiment, the interface unit includes peripheral interface circuits (40, 41) that may be coupled to a peripheral device of a server. For the purpose of remote management, monitoring information and the like from the peripheral circuit can be transmitted easily to the host machine via the network interface circuit.

As another specific embodiment, the above-described semiconductor integrated circuit includes an encryption and decoding circuit (43) coupled to the internal bus. This facilitates securing the data confidentiality on a network.

Moreover, as further another specific embodiment, the above-described semiconductor integrated circuit includes a direct memory access controller (34) coupled to the common internal bus. This allows for reducing the load of data transfer by the central processing unit.

Moreover, as still another specific embodiment, the image processing unit may be coupled to a dedicated external buffer memory (44). This can prevent the performance degradation when the bandwidth of the external memory interface circuit is not sufficient, or the like.

Moreover, as yet another specific embodiment, the above-described semiconductor integrated circuit includes a reset logic circuit (36) for generating a first to a third internal reset signals that are supplied to the image processing unit, compression unit, and interface unit. The first internal reset signal (res_tp1) indicates a reset due to any one of a change in an external reset signal (RES), a timeout of a watchdog timer (35) while a setting of a first register (50) is reset-enabled, and a setting of a reset-enable for a second register (51). The second internal reset signal (res_tp2) indicates a reset due to either a change in the external reset signal or the timeout of a watchdog timer. The third internal reset signal (res_tp3) indicates a reset due to a change in the external reset signal. The use of the above-described three types of internal reset signals allows for resetting without inviting a shutdown of the whole server in order to dissolve an abnormality in a part of the circuitry, and is thus suitable for server management.

[2] A data processing system concerning a representative embodiment of the present invention comprises a host processor (2), a north bridge (3) coupled to the host processor, a main memory (9) coupled to the north bridge, a south bridge (4) coupled to the north bridge, an interface control LSI (20), a local memory(22), and a network interface controller (17). The interface control LSI is a semiconductor integrated circuit that includes in one semiconductor substrate: the image processing unit (23) that performs image processing in response to an input from the south bridge via the main band bus (15); the compression unit (24) coupled to the image processing unit and capable of compressing an image data; and the interface unit (25). The interface unit includes the central processing unit (31), external memory interface circuit (32), and network interface circuit (33) that are coupled to the common internal bus (30). The external memory interface circuit may be coupled to the local memory. The network interface circuit is coupled to the network interface controller via a sideband bus (21), the network interface controller being coupled to the main band bus. The compression unit is coupled to the common internal bus. The image processing unit is coupled to the external memory interface circuit by the dedicated internal bus (37). The image processing unit stores an image data into the local memory via the dedicated internal bus. The compression unit is capable of compressing the image data supplied from the image processing unit.

According to this, as described above, the image data for graphic processing by the image processing unit that responds to an instruction from the external bus will not conflict with the data for memory management on the common internal bus. The data transmission rates on the common internal bus and the dedicated internal bus are high. The memory can be commonized.

As a specific embodiment, the interface unit performs remote management of a server by using an interface function compliant with IPMI.

### 2. Description of Embodiments

Next, the embodiments will be described more in detail.

### [Main Board of PC Server]

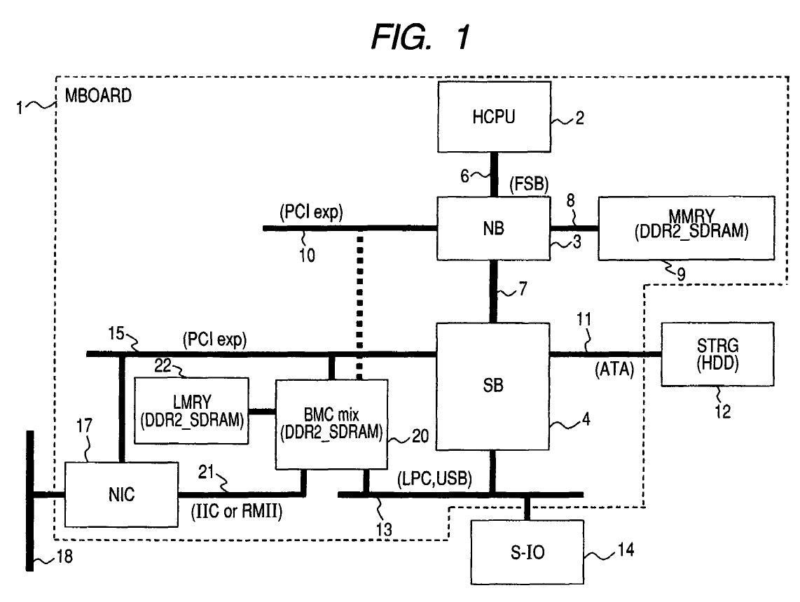

FIG. 1 illustrates a main board of a PC server as a data processing device concerning the present invention. A predetermined wiring pattern is formed on the surface of a main board (MBOARD) 1 and predetermined devices are mounted thereon. In the view, the main board 1 includes a host processor (HCPU) 2 as a host device, and includes, as a chip set, a north bridge (NB) 3 such as a memory control hub, and a south bridge (SB) 4 such as an I/O control hub. The host processor 2 is coupled to the north bridge 3. Various kinds of I/O's are coupled to the south bridge 4. The north bridge 3 and the host processor 2 are coupled to each other by a high-speed front side bus (FSB) 6. The north bridge 3 and the south bridge 4 are coupled to each other by a high-speed and exclusive link (HyperTransport, etc.) 7 of several Giga bps. The north bridge 3 includes interface functions, such as a CPU interface, a memory interface, and PCI_Express (designated by PCIexp). Reference numeral 8 represents a memory bus drawn from the north bridge 3, and a main memory (MMRY) 9 such as DDR2_SDRAM (Double Data Rate 2 Synchronous Dynamic Random Access Memory) is coupled thereto. Reference numeral 10 represents a PCIexp bus coupled to the north bridge 3, and a non-illustrated PCI device is coupled thereto. The south bridge 4 includes interface functions, such as PCI_Express, ATA, and LPC. Reference numeral 11 represents an ATA bus, and, for example, a disk storage drive (STRG) 12 such as HDD is coupled thereto. Reference numeral 13 represents a low speed bus, such as LPC (Low Pin Count), USB (Universal Serial Bus), or the like and is coupled to input output devices (S-I/O) 14, such as a mouse and a keyboard. Reference numeral 15 represents a PCIexp bus coupled to the south bridge 4, and a network interface controller (NIC) 17 is coupled thereto. The PCIexp bus 15 is regarded as a main band bus by the network interface controller 17. The network interface controller 17 performs the protocol control of Ethernet (registered trademark) and is coupled to a network cable 18. A BMC mixed LSI (BMCmix) 20, in which a BMC (Baseboard Management Controller) controller used for remote management of a server and the like are mixed and mounted together, is coupled to the south bridge 4 via the PCIexp bus 15 and LPC bus 13, and a local memory (LMRY) 22 is coupled to the BMC mixed LSI 20. The local memory 22 is a DDR2_SDRAM, for example. The BMC mixed LSI 20 is coupled to the network interface controller 17 also through a low speed bus 21 that is regarded as a sub-band bus. The low speed bus 21 is a bus such as RMII (Reduced Media Independent Interface) or IIC (Inter IC). In addition, since the BMC mixed LSI 20 includes a PCI_Express interface function, it may be coupled to the PCIexp bus 10 of the north bridge 3, as shown by a dotted line.

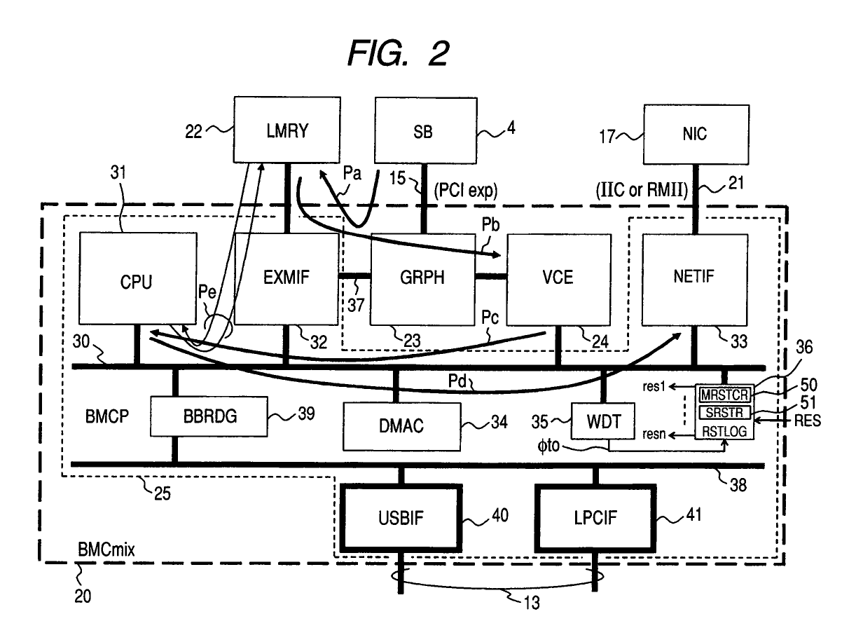

FIG. 2 shows an example of the BMC mixed LSI 20. The BMC mixed LSI 20 includes in one semiconductor substrate: an image processing unit (GRPH) 23 that performs image processing in response to an input from the south bridge 4 via the PCIexp bus 15; a compression unit (VCE) 24 coupled to an image processing unit 23 and capable of compressing an image data; and a BMC unit (BMCP) 25. The BMC unit 25 includes a central processing unit (CPU) 31, external memory interface circuit (EXMIF) 32, network interface circuit (NETIF) 33, direct memory access controller (DMAC) 34, watchdog timer (WDT) 35, and reset control logic circuit (RSTLOG) 36 that are coupled to a common internal bus 30. The common internal bus 30 is coupled to a peripheral bus 38 via a bus bridge circuit (BBRDG) 39, and the peripheral bus 38 is provided with a UBS interface circuit (USBIF) 40 and an LPC interface circuit (LPCIF) 41, and the low speed bus 13 is coupled to these interface circuits.

The external memory interface circuit 32 may be coupled to the local memory 22. The network interface circuit 33 is coupled to the network interface controller 17 via the low speed bus 21 as a side band bus. The compression unit 24 is coupled to the common internal bus 30.

Although not limited in particular, the common internal bus 30 is a split transaction bus of a packet switching method. Through the bus 30, a request packet containing a transfer request content and a response packet containing a reply content are exchanged. A circuit that issues a request packet and receives a response packet is called an initiator component and a circuit that receives a request packet and returns a response packet is called a target component, and the bus 30 includes the initiator component or the target component in a portion interfacing with the bus, depending on whether a circuit coupled to the bus is a bus master or a bus slave. Although illustration is omitted, this split transaction bus has a packet router that arbitrates the conflict between a request packet issued from the initiator component and a response packet issued from the target component.

The image processing unit 23 is coupled to the external memory interface circuit 32 by the dedicated internal bus 37. The image processing unit 23 receives a command from the south bridge 4 and performs image processing on an image data accordingly. The image processing unit 23 receives an image data from the south bridge 4 and performs image processing for drawing and displaying. The image processing unit controls the external memory interface circuit 32 via the dedicated internal bus 37, and accesses the local memory 22 as a data buffer of a received image data and as a work memory for image processing. The compression unit 24 performs compression of the image data supplied from the image processing unit 23 or of the image data read from the local memory 22. The compression unit 24 can use the local memory 22 via the external memory interface circuit 32 during the image compression processing.

The central processing unit 31 includes an instruction control unit and an execution unit. The instruction control unit controls an instruction execution sequence, and performs an instruction fetch and the decoding of the fetched instruction. The instruction control unit includes an instruction address calculator for calculating an instruction fetch address. In accordance with the result of instruction decoding, the execution unit executes an instruction by performing the calculation of an operand address and the data calculation for the operand. By executing a program stored in the local memory 22, the central processing unit 31 realizes an interface function compliant with IPMI and performs the remote management for managing and monitoring a server. As the remote management, the central processing unit 31 realizes, for example, a power on-off control function, a remote information collection function to collect events that occurred on the hardware of a server, a failure detection and notification function to notify the detection of a failure and the detected failure information from a server to an administration PC, a remote console function allowing for the key operation while watching a server side screen on an administration PC for a period from the power-on until the OS (Operating System) has booted, and the like. For example, as apart of the remote management function in a PC server using the main board 1, an operation such as follows is enabled: when operating a remote PC server (remote machine), the operation information of a keyboard, a mouse, and the like, is sent from a local computer (host machine) via a network 18, and then after executing the processing required on the remote machine, the host machine receives image information of a screen on the remote machine via the network and displays the same on a screen.

### [Data Transmission by Remote Management]

The data transmission operation realized by the remote management function is described. FIG. 2 illustrates a data flow when outputting image information of a screen on a remote machine to a host machine via a network. The image processing unit 23 receives a command (instruction) from the south bridge 4 and performs image processing on an image data accordingly. The image processing unit controls the external memory interface circuit 32 via the dedicated internal bus 37, and stores the received image data or the image-processed image data into the local memory 22 (path Pa). The image processing unit 23 sends the image data stored in the local memory 22 to the compression unit 24 (path Pb), and the compression unit compresses the image data supplied from the image processing unit 23. The central processing unit 31 supplies the compressed image data to the network interface controller 17 from the network interface circuit 33 (Paths Pc, Pd). Reference symbol Pe represents a path of an instruction fetch by the central processing unit 31.

As apparent from the transfer operation of the screen data on the remote machine, since the BMC mixed LSI 20 includes the image processing unit 23, compression unit 24, and BMC unit 25 in one semiconductor chip, the data transfer rate between these can be increased. As compared with the case where the BMC mixed LSI 20 is constructed from multi-chips, the data transfer rate between these can be increased, thus allowing for contribution to a low power consumption as well as a reduction in the number of components. Moreover, the dedicated internal bus 37, through which the image processing unit receives image information and stores the same into the external memory, is separated from the common internal bus 30. Since the central processing unit 31 together with the network interface circuit 33 for remote management is coupled to the common internal bus 30 and the dedicated internal bus 37 serves as a data path that is not required to go via this common internal bus 30, the image data for graphic processing by the image processing unit 23 that responds to an instruction from the south bridge 4 will not conflict with other data for memory management on the common internal bus 30. This point also contributes to increase in the above-described data transfer rate. Moreover, the local memory 22 coupled to the external memory interface circuit 32 can be used also for a buffer memory for image compression, a work memory of the central processing unit 31, and the like, and thus the memory can be commonized. The image processing unit 23, the compression unit 24, and the BMC unit 25 individually may not have a work memory, respectively.

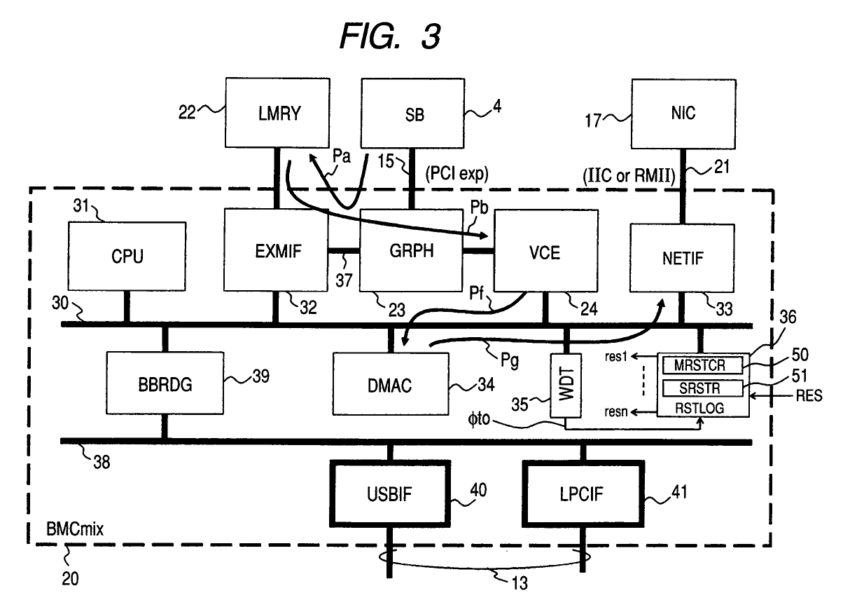

FIG. 3 illustrates a data flow when using DMAC for outputting image information of a screen on a remote machine to a host machine via a network. The difference from FIG. 2 is that when supplying an image data compressed by the compression unit 24 from the network interface circuit 33 to the network interface controller 17, DMAC 34 performs the data transfer control (Paths Pf, Pg). This can reduce the load of the central processing unit 31. The setting of the data transfer control condition for DMAC 34 is made in advance by the central processing unit 31. The operation of this condition setting may be made during the operation of the image processing unit 23 or the compression unit 24. Since the common internal bus 30 and the dedicated internal bus 37 are separated from each other, their operations and the operation of the condition setting will not conflict on the bus.

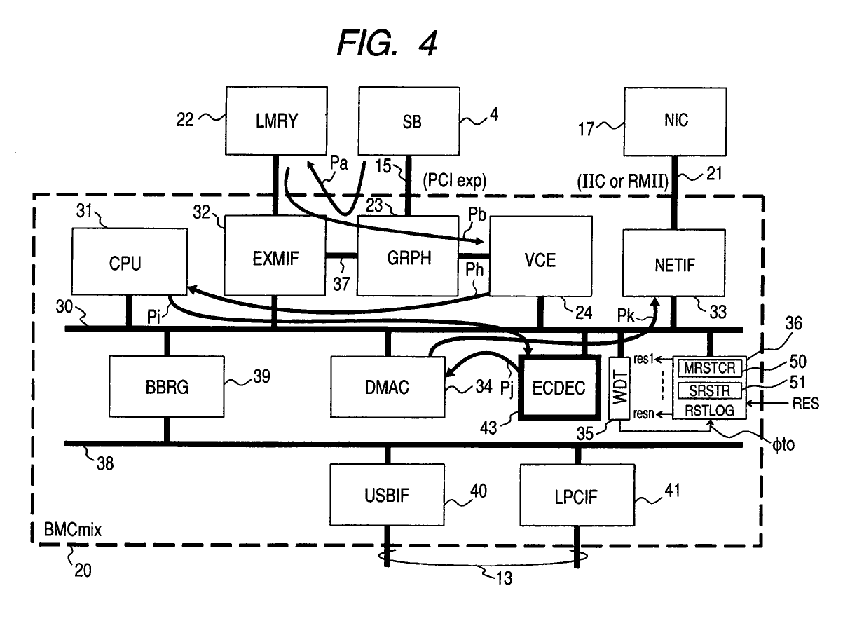

FIG. 4 illustrates a data flow when encrypting for outputting image information of a screen on a remote machine to a host machine via a network. The first difference from FIG. 3 is that an encryption and decoding circuit (ECDEC) 43 is arranged in the common internal bus 30. Although not limited in particular, the encryption and decoding circuit 43 performs encryption or decode processing of a data in accordance with an instruction from the central processing unit 31. The second difference is that when an image data compressed by the compression unit 24 is encrypted by the encryption and decoding circuit 43 in accordance with an instruction of the central processing unit 31 (Paths Ph, Pi) and the thus encrypted data is supplied from the network interface circuit 33 to the network interface controller 17, DMAC 34 performs the data transfer control (Paths Pj, Pk). This may improve the confidentiality of data transferred through a network, and may improve the resistance against the data abuse and the like by others.

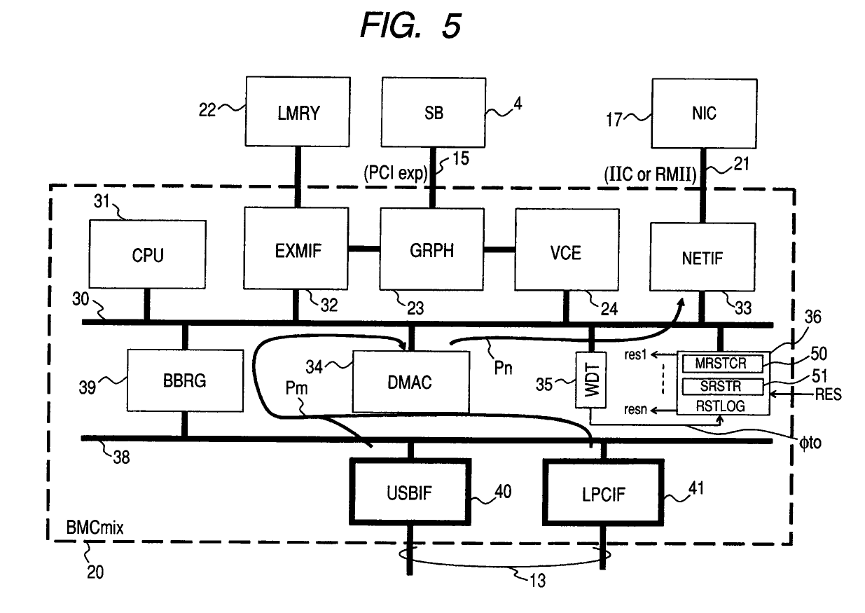

FIG. 5 illustrates a data flow when outputting the information on peripheral devices, such as a keyboard and a mouse, on a remote machine, to a host machine via a network. When the information on the peripheral devices that is input to USBIF 40 or LPCIF 41 is supplied from the network interface circuit 33 to the network interface controller 17, DMAC 34 performs the data transfer control (Paths Pm, Pn). In place of the control of DMAC 34, the central processing unit 31 may perform the transfer control, directly.

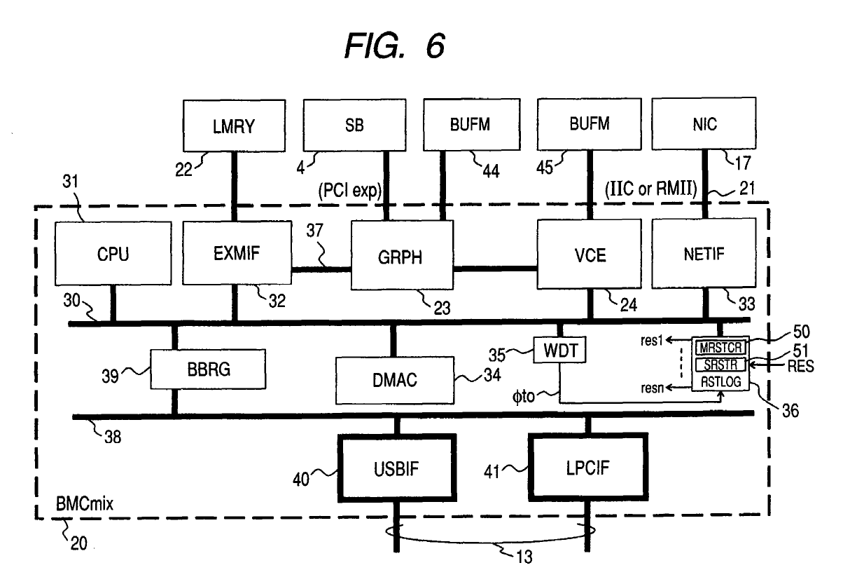

FIG. 6 illustrates an example of the BMC mixed LSI, in which a buffer memory is provided in each of the image processing unit and the compression unit. A dedicated buffer memory (BUFM) 44 is provided in the image processing unit 23, and a dedicated buffer memory (BUFM) 45 is provided in the compression unit 24. This may avoid the performance degradation when the bandwidth of the external memory interface circuit 32 is not sufficient, or the like. However, the number of external terminals of the BMC mixed LSI 20 and the package size will increase accordingly.

### [Reset Function]

Next, a reset function of the BMC mixed LSI is described. The watchdog timer 35 illustrated in FIG. 2 and the like includes a counter that restarts the count operation from an initial value each time the counter reset is performed at a predetermined interval, and when the counter reset is not performed at the predetermined interval, the watchdog timer 35 will output a timeout signal fto. A reset control logic circuit 36 includes a manual reset control register (MRSTCR) 50 and a software reset register (SRSTR) 51, and upon input of an external reset signal RES, the timeout signal fto is input to generate internal reset signals res1 to resn for the internal circuitry of the BMC mixed LSI 20. The internal reset signals res1 to resn are grouped into any one of first to third types.

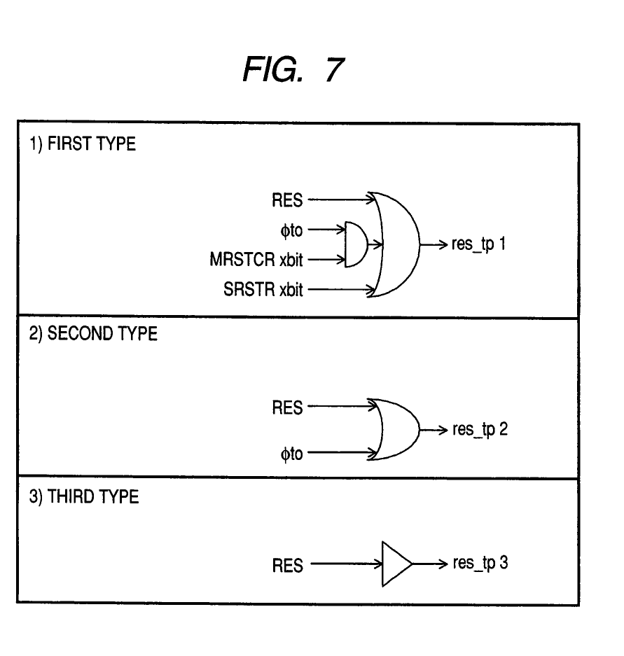

FIG. 7 illustrates the meanings of the first to third types of the internal reset signals. An internal reset signal res_tp1 of the first type will indicate a reset due to any one of the activation of the external reset signal RES, the activation of the timeout signal fto while the setting of a corresponding bit of MRSTCR 50 is reset-enabled, and the setting of a reset-enable for a corresponding bit of SRSTR 51. The corresponding bits of MRSTCR 50 and SRSTR 51 mean a bit assigned for each of the internal reset signals of the first type. Accordingly, in which case the internal reset signal res_tp1 of the first type is activated is determined according to the setting contents of MRSTCR 50 and SRSTR 51. Although MRSTCR 50 and SRSTR 51 are set to an initial value at the time of reset, thereafter they are made programmably configurable by the central processing unit 31, and thus an event to indicate a reset and a circuit to be reset can be variably controlled according to the internal state of the PC server. As for an internal reset signal res_tp2 of the second type, the second internal reset signal indicates a reset due to either the activation of the external reset signal RES or the activation of the timeout signal fto. A third internal reset signal res_tp3 indicates a reset due to the activation of the external reset signal RES. The use of the above-described three types of internal reset signals allows for resetting without inviting a shutdown of the whole server in order to dissolve an abnormality in a part of the circuitry, and is thus suitable for server management. In addition, some of the internal reset signals may be used for a reset signal to an external circuit of the BMC mixed LSI 20, via a port.

The reset operation of the BMC mixed LSI 20 is selected so that the PC server may continue the operation as long as possible. When the central processing unit 31 stops operating normally, a general reset is performed using the external reset signal RES or the timeout signal fto of the watchdog timer. When the internal circuit coupled to the peripheral bus 38 stops operating normally, the corresponding bit of SRSTR 51 may be set to software-reset only a corresponding circuit. When a circuit coupled to the common internal bus 30 serving as the split transaction bus stops operating normally, a software reset has to be performed after comprehending the conditions of the target component and the initiator component. This is because a return of a response packet from the target component in response to an issued request packet by the initiator component depends on the arbitration and timing control by a packet router, which is different from the bus control that completes within the unit of operation cycle of a bus.

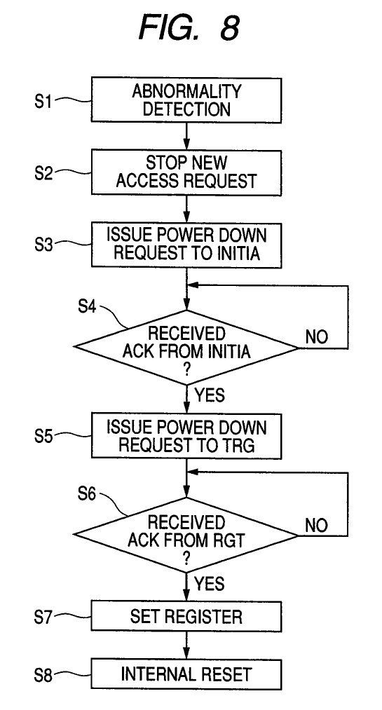

FIG. 8 illustrates an internal reset control procedure by the central processing unit for the internal circuit coupled to the common internal bus. For example, when detecting an abnormality (S1), the central processing unit 31 stops a new access using the common internal bus 30 except for the purpose of performing the processing required for reset (S2). Next, the central processing unit 31 issues a power down request to an initiator component (INITIA) (S3) and waits for an acknowledgement of the power down for that request (S4). After confirming the power down of the initiator component, the central processing unit 31 issues a power down request to a target component (TRG) (S5) and waits for an acknowledgement of the power down for that request (S6). After confirming the power down of the target component, the central processing unit 31 sets the corresponding bit of SRSTR 51 (S7), thereby software-resetting the corresponding circuit (S8).

As described above, although the invention made by the present inventor has been described specifically based on the embodiments, it is apparent that the present invention is not limited thereto and various modifications may be made without departing from the scope of the invention.

For example, the bus structure of the BMC mixed LSI is not limited to the one in FIG. 2 and the like, but may be modified suitably, and the peripheral bus 38 may be further hierarchized so that an interface circuit with various peripheral functions is coupled thereto. Moreover, the present invention can be applied not only to a remote system that operates a remote computer via a network, but also to the server of a general server client system, further to a video delivery server, or also to a general personal computer equipped with a remote management function, and the like.

What is claimed is:

1. A semiconductor integrated circuit comprising in one semiconductor substrate:
an image processing unit that performs image processing in response to an input from an external bus;
a compression unit coupled to the image processing unit and capable of compressing an image data; and
an interface unit that may be utilized for server management,
wherein the interface unit includes:
a central processing unit;
an external memory interface circuit; and
a network interface circuit that are coupled to a common internal bus, respectively;
wherein the external memory interface circuit may be coupled to an external memory,
wherein the network interface circuit may be coupled to an external network controller,
wherein the compression unit is coupled to the common internal bus, and
wherein the image processing unit is coupled to the external memory interface circuit by a dedicated internal bus,
wherein the image processing unit stores an image data into the external memory via the dedicated internal bus, and
wherein the compression unit is capable of compressing the image data supplied from the image processing unit.

2. The semiconductor integrated circuit according to claim 1, wherein the interface unit includes a peripheral interface circuit that may be coupled to a peripheral device of a server.

3. The semiconductor integrated circuit according to claim 1, further comprising an encryption and decoding circuit coupled to the internal bus.

4. The semiconductor integrated circuit according to claim 1, further comprising a direct memory access controller coupled to the common internal bus.

5. The semiconductor integrated circuit according to claim 1, wherein the image processing unit may be coupled to a dedicated external buffer memory.

6. The semiconductor integrated circuit according to claim 1, further comprising:
a reset logic circuit for generating a first to a third internal reset signals that are supplied to the image processing unit, the compression unit, and the interface unit,
wherein the first internal reset signal indicates a reset due to any one of a change in an external reset signal, a timeout of a watchdog timer while a setting of a first register is reset-enabled, and a setting of a reset-enable for a second register,
wherein the second internal reset signal indicates a reset due to either a change in the external reset signal or a timeout of the watchdog timer, and
wherein the third internal reset signal indicates a reset due to a change in the external reset signal.

7. A data processing system, comprising:
a host processor;
a north bridge coupled to the host processor;
a main memory coupled to the north bridge;
a south bridge coupled to the north bridge;
an interface control LSI;
a local memory; and
a network interface controller,
wherein the interface control LSI is a semiconductor integrated circuit that includes in one semiconductor substrate, includes:
an image processing unit that performs image processing in response to an input from the south bridge via a main band bus;
a compression unit coupled to the image processing unit and capable of compressing an image data; and
an interface unit,
wherein the interface unit includes:
a central processing unit;
an external memory interface circuit; and
a network interface circuit that are coupled to a common internal bus, respectively,
wherein the external memory interface circuit may be coupled to the local memory,
wherein the network interface circuit is coupled to the network interface controller via a sub-band bus,
wherein the network interface controller being coupled to the main band bus,
wherein the compression unit is coupled to the common internal bus,
wherein the image processing unit is coupled to the external memory interface circuit by a dedicated internal bus, and the image processing unit stores an image data into the local memory via the dedicated internal bus, and
wherein the compression unit is capable of compressing the image data supplied from the image processing unit.

8. The data processing system according to claim 7, wherein the interface unit performs remote management of a server by using an interface function compliant with IPMI.

9. The data processing system according to claim 7, wherein the interface unit includes a peripheral interface circuit that may be coupled to the south bridge via a peripheral bus.

10. The data processing system according to claim 7, further comprising an encryption and decoding circuit coupled to the internal bus.

11. The data processing system according to claim 7, further comprising a direct memory access controller coupled to the common internal bus.

12. The data processing system according to claim 7, wherein the image processing unit is coupled to a dedicated external buffer memory.

13. The data processing system according to claim 7, further comprising a reset logic circuit for generating a first to a third internal reset signals that are supplied to the image processing unit, the compression unit, and the interface unit,
wherein the first internal reset signal indicates a reset due to any one of a change in an external reset signal, a timeout of a watchdog timer while a setting of a first register is reset-enabled, and a setting of a reset-enable for a second register;
wherein the second internal reset signal indicates a reset due to either a change in the external reset signal, or a timeout of the watchdog timer; and
wherein the third internal reset signal indicates a reset due to a change in the external reset signal.
